(19) United States
(12) Patent Application Publication
(10) Pub. No.: US 2009/0323653 A1
(43) Pub. Date: Dec. 31, 2009

(54) Communication service support device, method and program

(75) Inventors: Masahide Noda, Kawasaki (JP); Kazuki Matsui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/385,264

(22) Filed: Apr. 2, 2009

(30) Foreign Application Priority Data
Jun. 30, 2008 (JP) 2008-171349

(51) Int. Cl. H04W 4/02

(52) U.S. Cl. 370/338; 455/414.1; 455/435.1

(57) ABSTRACT

A communication service support device includes a parameter storage, a terminal information storage, a comparator, a register, and a notifier. The parameter storage stores, in a manner associated with one another, identification information identifying multiple mobile terminal units, identification information identifying multiple points, identification information identifying service that the individual mobile terminal units can receive at the respective points, and identification information identifying management servers for managing the respective points. The comparator compares the identification information stored in the parameter storage and identifying the management servers with identification information transmitted from a mobile terminal unit at a point and identifying a management server. When agreement of the identification information is found as a result of the comparison, the notifier notifies the mobile terminal unit from which the identification information identifying the management server has been received that the mobile terminal unit is permitted to use the service.

### CROSS-REFERENCE TO RELATED APPLICATIONS

This application is based upon and claims the benefit of priority of the prior Japanese Patent Application No. 2008-171349, filed on Jun. 30, 2008, the entire contents of which are incorporated herein by reference.

### FIELD

The embodiments discussed herein are related to devices, methods and programs for supporting communication services.

### BACKGROUND

In recent years, an increasing number of business enterprises have been adopting IP-PBXs (Internet Protocol Private Branch exchanges) as their telephone systems. Also, services for mobile IP telephone terminals (hereinafter referred to as “mobile terminal units”), which are provided via wireless LANs (Local Area Networks) with the use of the telephone systems, have already been launched (see, e.g., PCT-based Japanese Laid-open Patent Publication No. 2001-523875 and Japanese Laid-open Patent Publication No. 2006-129205).

By carrying around their mobile terminal units, users can enjoy the increased convenience of making telephone calls at various points (offices, factories, stores, etc.).

Further, the scope of service available to mobile terminal units is not limited to an extension call service alone but covers various kinds of services assisting the extension call service (hereinafter referred to as “extension call supplementary services”).

Even if the user moves from one point to another, he/she can make and receive a call without the need to change the telephone number at each point. Namely, the user can make use of the extension call service regardless of the point where he/she is.

When using an extension call supplementary service, on the other hand, the user may possibly be unable to receive the service appropriate to the place unless he/she is aware of the point where the mobile terminal unit is located (the point from and to which the mobile terminal unit is moved).

Let us consider a group call service by way of example. The group call service is an extension call supplementary service whereby an incoming call to a group pilot number is routed to multiple mobile terminal units.

In the case of this service, if the points where the respective mobile terminal units are located are not taken into consideration, an incoming group call to a point A, for example, is routed also to a mobile terminal unit existing at a different point B from the point A, giving rise to a problem that the group call service fails to attain its intended purpose.

As another example, let us consider a call parking service. The call parking service is an extension call supplementary service whereby, by pressing, during a telephone conversation, a call park button assigned to the external line button, for example, the user can put the call on hold while specifying a parking number and continue the conversation later from a desired telephone set.

In the case of the call parking service, if the user at the point B parks a call by inputting an instruction that is applicable to the point A, then the call is parked in the parking pool associated with the point A. A problem therefore arises in that the parked call cannot be answered from the other mobile terminal units at the point B.

As still another example, let us consider a call pickup service whereby, with the mobile terminal unit at hand, the user can receive an incoming call to a different mobile terminal unit located at the same point.

In the case of this service, if the user's mobile terminal unit is not included in the pickup group set in the IP-PBX, the user at the point B is unable to pick up an incoming call to a nearby mobile terminal unit located at same point B, even if he/she performs a pickup operation on his/her mobile terminal unit.

Also, even if the user is allowed to designate a pickup group of mobile terminal units, he/she needs to be always aware whether he/she is at the point A or B when performing an operation on his/her mobile terminal unit, increasing the burden on the user.

Thus, if the settings of the mobile terminal unit alone are changed to enable the call function, for example, with no change made to the settings of the IP-PBX, inconsistency arises between the settings of the IP-PBX and those of the mobile terminal unit, giving rise to the problems mentioned above.

Also, if the location detected by the IP-PBX disagrees with an actual location of the mobile terminal unit because of some error or other, inconsistency between the settings of the IP-PBX and those of the mobile terminal unit arises, similarly causing the aforementioned problems.

### SUMMARY

According to one aspect of the embodiments, a communication service support device for permitting a plurality of mobile terminal units to use services includes a parameter storage configured to store, in a manner associated with one another, identification information identifying the respective mobile terminal units, identification information identifying a plurality of points, respectively, identification information identifying the services that the individual mobile terminal units are allowed to receive at each of the points, and identification information identifying management servers for managing the respective points, a comparator configured to compare the identification information stored in the parameter storage and identifying the management servers with identification information transmitted from a mobile terminal unit at one of the points and identifying one of the management servers, and a notifier configured to notify, when agreement of the identification information is found as a result of the comparison by the comparator, the mobile terminal unit from which the identification information identifying the management server has been received that the mobile terminal unit is permitted to use the service.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 schematically illustrates a communication service support device according to an embodiment;

FIG. 2 illustrates a system configuration;

FIG. 3 illustrates information stored in a location information server;

FIG. 4 illustrates an exemplary hardware configuration of a PBX (Private Branch exchange);

FIG. 5 is a block diagram illustrating functions of the PBX;

FIG. 6 is a block diagram illustrating functions of a mobile terminal unit;

FIG. 7 illustrates information stored in a supplementary service parameter storage;

FIG. 8 illustrates information stored in a supplementary service setting information storage;

FIG. 9 is a sequence diagram illustrating operation of a system according to a first embodiment;

FIG. 10 is a flowchart illustrating operation of a terminal/point verifier;

FIG. 11 is a flowchart illustrating a process executed by the mobile terminal unit;

FIG. 12 is a sequence diagram illustrating a process executed in the case where the terminal/point verifier is configured to generate a terminal management server identifier;

FIG. 13 is a block diagram illustrating functions of a PBX according to a second embodiment;

FIG. 14 is a block diagram illustrating functions of a mobile terminal unit according to the second embodiment;

FIG. 15 illustrates a supplementary service parameter management table according to the second embodiment;

FIG. 16 is a sequence diagram illustrating operation of a system according to the second embodiment;

FIG. 17 is a flowchart illustrating a process executed by the mobile terminal unit according to the second embodiment;

FIG. 18 illustrates a supplementary service parameter management table according to a third embodiment;

FIG. 19 illustrates a supplementary service setting information management table according to the third embodiment;

FIG. 20 is a sequence diagram illustrating operation of a system according to the third embodiment; and

FIG. 21 is a flowchart illustrating operation of a terminal/point verifier according to the third embodiment.

### DESCRIPTION OF EMBODIMENTS

Embodiments of the present invention will be described below with reference to the accompanying drawings, wherein like reference numerals refer to like elements throughout.

First, a communication service support device according to an embodiment will be described, and then specific embodiments will be explained in detail.

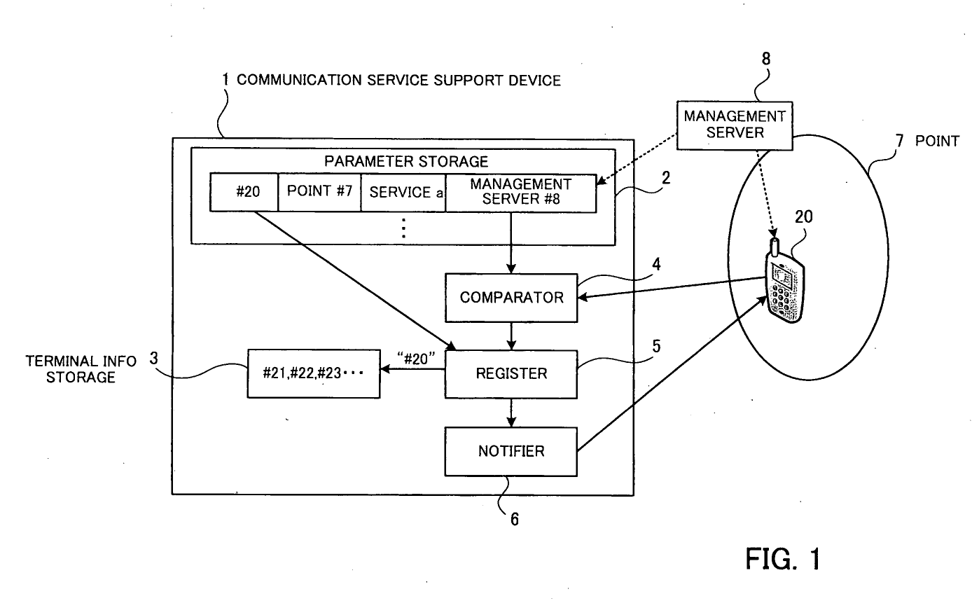

FIG. 1 schematically illustrates the communication service support device according to the embodiment.

The communication service support device 1 illustrated in FIG. 1 is configured to permit a plurality of mobile terminal units to use a service. The type of service to be provided to the mobile terminal units is not particularly limited and may be an extension call supplementary service (group call service, call parking service, pickup service) or the like.

The communication service support device 1 comprises a parameter storage 2, a terminal information storage 3, a comparator 4, a register 5, and a notifier 6.

The parameter storage 2 stores, in a manner associated with one another, identification information identifying the respective mobile terminal units, identification information identifying a plurality of points, respectively, identification information identifying the service that the individual mobile terminal units are allowed to receive at each of the points, and identification information identifying management servers for managing the respective points. In FIG. 1, identification information “#20” identifying a mobile terminal unit 20, identification information “point #7” identifying a point 7, service identification information “service a” and identification information “management server #8” identifying a management server 8 for managing the point 7 are stored in a manner associated with one another.

The terminal information storage 3 stores identification information identifying mobile terminal units that are permitted to use the service. The communication service support device 1 permits those mobile terminal units of which the identification information is stored in the terminal information storage 3 to use the service.

In FIG. 1, the mobile terminal units with identifications “#21”, “#22”, “#23”, . . . are permitted to use the service a.

The comparator 4 compares the identification information stored in the parameter storage 2 and identifying the respective management servers with identification information transmitted from a mobile terminal unit at a certain point and identifying a management server.

In FIG. 1, identification information identifying the management server 8 is transmitted from the mobile terminal unit 20 at the point 7. This identification information is sent in advance from the management server 8 to the mobile terminal unit 20.

If the two identifications compared by the comparator 4 agree with each other, the register 5 registers, in the terminal information storage 3, identification information identifying the mobile terminal unit from which the identification information has been received.

In FIG. 1, the register 5 acquires the identification information “#20” of the mobile terminal unit 20 from the parameter storage 2 and registers the acquired identification information in the terminal information storage 3. Thereupon, the communication service support device 1 permits the mobile terminal unit 20 to use the service a.

The communication service support device 1 is provided with the terminal information storage 3 and the register 5 in cases where the communication service support device 1 needs to manage the settings of the mobile terminal units. Thus, in the case of a service implemented solely in accordance with the settings stored in the mobile terminal units, the terminal information storage 3 and the register 5 may be omitted.

When the two identifications compared by the comparator 4 agree with each other, the notifier 6 notifies the mobile terminal unit from which the identification information identifying the management server has been received that the mobile terminal unit is permitted to use the service.

In FIG. 1, the notifier 6 notifies the mobile terminal unit 20 of permission to use the service. Thus, the mobile terminal unit 20 can use the service a.

In the communication service support device 1 configured as described above, the comparator 4 confirms agreement of the identification information “management server #8” stored in the parameter storage 2 and identifying the management server 8 with the identification information “management server #8” transmitted from the mobile terminal unit 20 and identifying the management server 8. The register 5 then registers the identification information “#20” of the mobile terminal unit 20 in the terminal information storage 3. Subsequently, the mobile terminal unit 20 is notified of permission to use the service. It is therefore possible to maintain consistency between the communication service support device 1 and the mobile terminal unit 20 as to the settings of the service.

The embodiments will be now described in more detail.

### First Embodiment

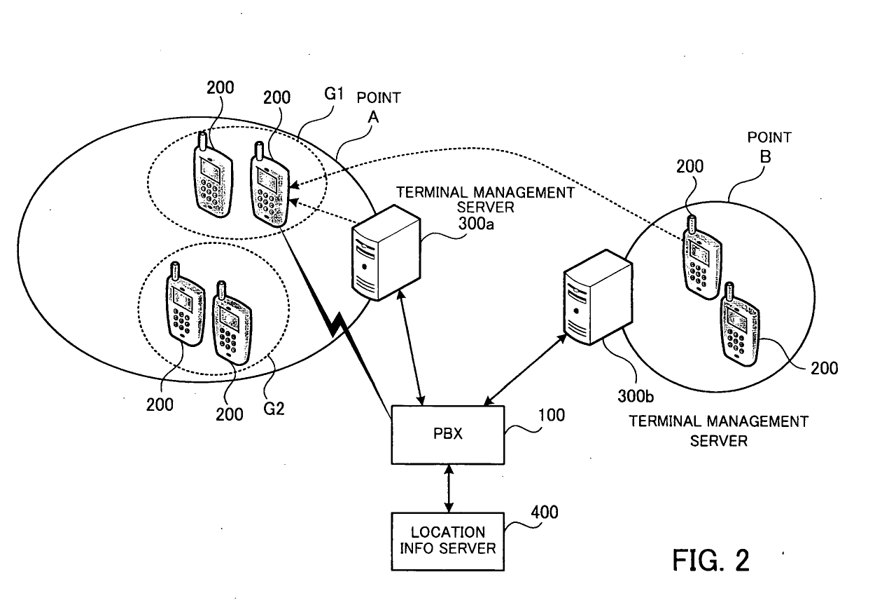

FIG. 2 exemplifies the configuration of a system.

The system illustrated in FIG. 2 comprises a PBX 100, a plurality of mobile terminal units 200, a location information server 400, and terminal management servers 300a and 300b.

The PBX 100 carries out circuit switching for the mobile terminal units (IP telephone terminal units) 200 within an IP network.

Each mobile terminal unit 200 has the function of receiving the extension call service and the extension call supplementary services.

Also, each mobile terminal unit 200 is assigned a unique telephone number (terminal identifier).

The terminal management servers 300a and 300b are associated with respective different points A and B and have the function of managing the respective points. Specifically, each of the terminal management servers 300a and 300b provides the mobile terminal units 200 existing at the corresponding point with its terminal management server identifier (described later) uniquely assigned thereto.

The scheme of communication between the terminal management server 300a and each mobile terminal unit 200 is not particularly limited and preferably may be a scheme in which communication is available only when the mobile terminal unit 200 exists at the specified point. Specific examples include a near-field wired communication scheme using USB (Universal Serial Bus) or the like, and a near-field wireless communication scheme using Bluetooth or the like. IP technology may of course be used on condition that data can be received only at the specified point.

Such a communication scheme makes it possible to ascertain with higher reliability that the individual mobile terminal units 200 exist at the specified point.

Service using such a communication scheme may be implemented, for example, by providing the entrance of a partitioned place (point) with a reader/writer for allowing the terminal management server 300a to communicate with the mobile terminal units 200 and having each user bring his/her mobile terminal unit 200 close to the reader/writer when entering the place (point).

A plurality of groups, each indicative of a unit making use of an identical extension call supplementary service, may be set within a single point as needed. In FIG. 2, groups G1 and G2 are set within the point A. The groups correspond, in this embodiment, to call receiving groups, explained later, and in a third embodiment described later, to pickup groups.

The location information server 400 manages, with respect to each point, information about the locations of the individual mobile terminal units 200. Specifically, the location information server 400 has the function of ascertaining to which wireless LAN access points the IP addresses of the individual mobile terminal units 200 belong.

Information stored in the location information server 400 will be now explained.

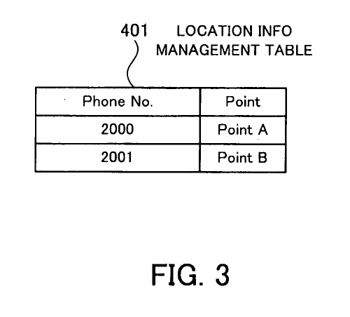

FIG. 3 illustrates the information stored in the location information server. The location information server 400 stores the information in tabular form.

A location information management table 401 has columns labeled “Phone No.” and “Point”, and the information items in each row are associated with each other.

In the “Phone No.” column, a telephone number uniquely identifying a mobile terminal unit 200 is set.

In the “Point” column is set the name of the point where the mobile terminal unit 200 with the telephone number specified in the “Phone No.” column is currently located. Thus, it is possible to obtain information that the mobile terminal unit 200 with the telephone number “2000”, for example, is currently located at the point A.

Referring again to FIG. 2, process performed by the system will be briefly explained.

In the illustrated system, when a mobile terminal unit 200 is moved from the point B to the point A, for example, the mobile terminal unit 200 outputs, to the PBX 100, a request for permission to use the extension call supplementary service.

The PBX 100 confirms on the basis of the information held by the location information server 400 that the moved mobile terminal unit 200 is currently located at the point A. Then, the PBX 100 instructs the terminal management server 300a, which manages the point A, to send its unique identifier to the mobile terminal unit 200. Also, the PBX 100 requests the terminal management server 300a to notify its unique identifier.

The mobile terminal unit 200 again outputs a request for permission to use the extension call supplementary service, together with the received unique identifier.

On confirming the agreement of the unique identifier received from the terminal management server 300a with the one received from the mobile terminal unit 200, the PBX 100 permits the mobile terminal unit 200 to make use of the extension call supplementary service. It is therefore possible to maintain consistency between the PBX 100 and the mobile terminal unit 200 as to the settings of the extension call supplementary service.

The PBX 100 will be now explained in detail.

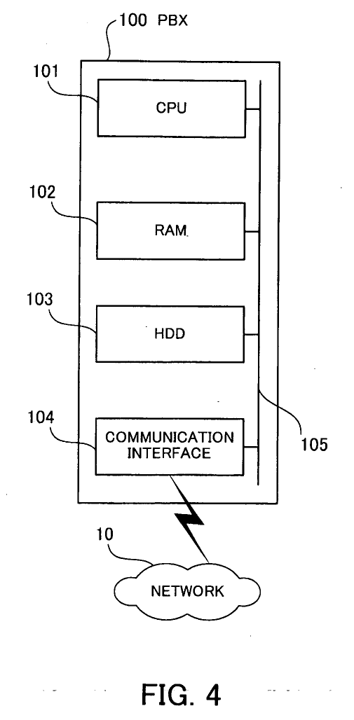

FIG. 4 illustrates an exemplary hardware configuration of the PBX.

The PBX 100 operates under the control of a CPU (Central Processing Unit) 101. The CPU 101 is connected via a bus 105 with a RAM (Random Access Memory) 102, an HDD (Hard Disk Drive) 103, and a communication interface 104.

The RAM 102 temporarily stores at least part of an OS (Operating System) and application program executed by the CPU 101. Also, the RAM 102 stores various data necessary for the process of the CPU 101. The HDD 103 stores the OS and application programs. Also, program files are stored in the HDD 103.

The communication interface 104 is connected to a network 10 and transmits/receives data to/from other computers through the network 10.

With the hardware configuration described above, the processing function of this embodiment can be accomplished. To determine whether to permit the mobile terminal unit 200 to use the extension call supplementary service provided by the system with the above hardware configuration, the PBX 100 has functions described below.

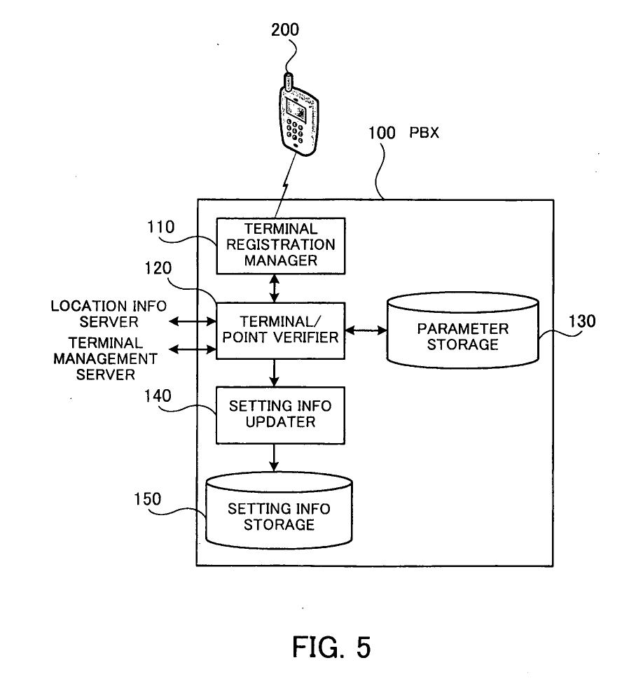

FIG. 5 is a block diagram illustrating the functions of the PBX.

The PBX 100 comprises a terminal registration manager 110, a terminal/point verifier 120, a supplementary service parameter storage 130, a supplementary service setting information updater 140, and a supplementary service setting information storage (terminal information storage) 150.

The terminal registration manager 110 receives information from the mobile terminal unit 200 and sends the received information to the terminal/point verifier 120. Also, the terminal registration manager 110 receives information from the terminal/point verifier 120 and transmits the received information to the mobile terminal unit 200. As a communication protocol for communicating with the mobile terminal unit 200, SIP (Session Initiation Protocol) is used, for example.

The terminal/point verifier 120 acquires information from the location information server 400 whenever necessary, and determines, based on the information received from the terminal registration manager 110, whether to register the mobile terminal unit 200 which is requesting registration, as a mobile terminal unit permitted to access the extension call supplementary service. When permitting registration with the extension call supplementary service, the terminal/point verifier 120 sends a setting information update instruction to the supplementary service setting information updater 140.

On the other hand, when refusing registration with the extension call supplementary service, the terminal/point verifier 120 instructs the terminal management server in charge of managing the point where the mobile terminal unit 200 is located, to transmit its terminal management server identifier to the mobile terminal unit 200.

The supplementary service parameter storage 130 stores information used by the terminal/point verifier 120 when making the aforementioned determination.

When the setting information update instruction is received from the terminal/point verifier 120, the supplementary service setting information updater 140 updates (overwrites) the information stored in the supplementary service setting information storage 150.

The supplementary service setting information storage 150 stores information about groups in the individual points and the mobile terminal units 200 belonging to the respective groups. The PBX 100 permits the mobile terminal units 200 belonging to the groups registered in the supplementary service setting information storage 150, to use the corresponding extension call supplementary service.

Functions of the mobile terminal unit 200 will be now described.

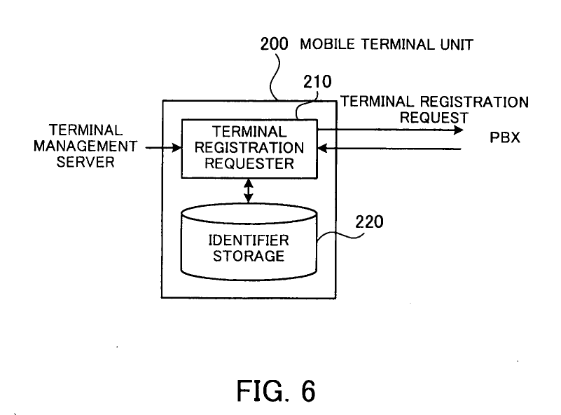

FIG. 6 is a block diagram illustrating the functions of the mobile terminal unit.

The mobile terminal unit 200 comprises a terminal registration requester 210 and an identifier storage 220.

As the mobile terminal unit 200 moves from point to point, the terminal registration requester 210 transmits, to the PBX 100, a terminal registration request (REGISTER) to request registration with the extension call supplementary service.

The terminal registration request includes a field for storing the telephone number unique to the mobile terminal unit 200, and a field for storing the terminal management server identifier.

When transmitting the terminal registration request, the terminal registration requester 210 includes, in the first-mentioned field, the telephone number unique to the mobile terminal unit 200. Also, where the terminal management server identifier has already been received from the terminal management server 300a or 300b, the terminal registration requester 210 includes the terminal management server identifier in the terminal management server identifier storage field.

Also, when the terminal management server identifier is received from the terminal management server 300a or 300b, the terminal registration requester 210 stores the received terminal management server identifier in the identifier storage 220.

Information stored in the supplementary service parameter storage 130 will be now explained.

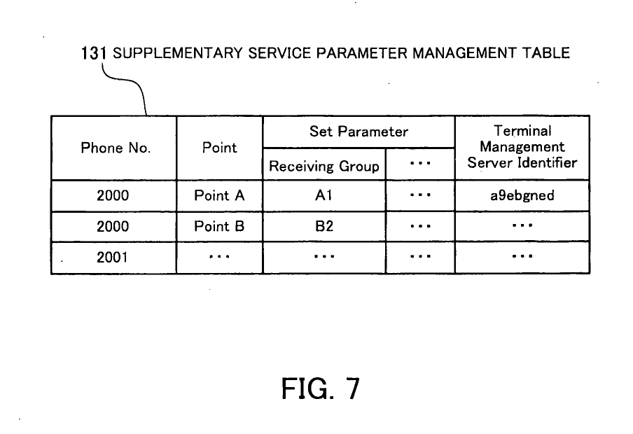

FIG. 7 illustrates the information stored in the supplementary service parameter storage. The supplementary service parameter storage 130 stores information in tabular form.

A supplementary service parameter management table 131 has columns labeled “Phone No.”, “Point”, “Set Parameter”, and “Terminal Management Server Identifier”. The information items in each row are associated with one another.

In the “Phone No.” column, information uniquely identifying a mobile terminal unit 200 is set.

In the “Point” column is set information identifying the point where the mobile terminal unit 200 specified in the “Phone No.” column is currently located.

In the “Set Parameter” column, a parameter is set which is used in providing the extension call supplementary service in accordance with the settings of the PBX 100 when the mobile terminal unit 200 is located at the point specified in the “Point” column. In FIG. 7, call receiving group is set as a set parameter. The call receiving group represents a group unit for which the group call service is provided.

In the “Receiving Group” column is set information identifying a receiving group to which the mobile terminal unit 200 belongs when located at the point specified in the “Point” column. Thus, when the mobile terminal unit 200 with the telephone number “2000” is located at the point A, for example, the mobile terminal unit 200 belongs to a receiving group A1. At the point B, on the other hand, the mobile terminal unit 200 belongs to a receiving group B2.

As illustrated in FIG. 7, a plurality of parameters used for providing the extension call supplementary service may be set under the “Set Parameter” column.

In the “Terminal Management Server Identifier” column, information identifying the location of the mobile terminal unit 200 is set with respect to each receiving group when the identification information is received from the mobile terminal unit 200.

The terminal management server identifier is set with respect only to the receiving group to which the mobile terminal unit 200 currently belongs.

In the following description, the group call service will be taken as an example of the extension call supplementary service.

Information stored in the supplementary service setting information storage 150 will be now described.

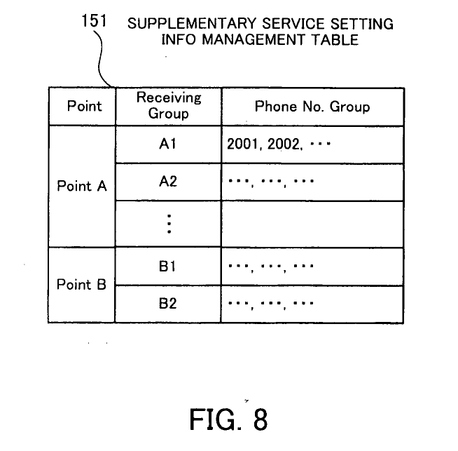

FIG. 8 illustrates the information stored in the supplementary service setting information storage. The supplementary service setting information storage 150 stores information in tabular form.

A supplementary service setting information management table 151 has columns labeled “Point”, “Receiving Group”, and “Phone No. Group”. The information items in each row are associated with one another.

In the “Point” and “Receiving Group” columns, information items identical in content with those explained above with reference to the supplementary service parameter management table 131 are set.

In the “Phone No. Group” column are set the telephone numbers of the mobile terminal units 200 currently belonging to the receiving group specified in the “Receiving Group” column, namely, the telephone numbers of the mobile terminal units 200 that are allowed to use the group call service.

In FIG. 8, a plurality of receiving groups A1, A2, . . . are set with respect to the point A, and the mobile terminal units 200 with the telephone numbers “2001”, “2002”, . . . currently belong to the receiving group A1.

Operation of the system according to the first embodiment will be now described with reference to an exemplary case where the mobile terminal unit 200 has been moved from the point B to the point A.

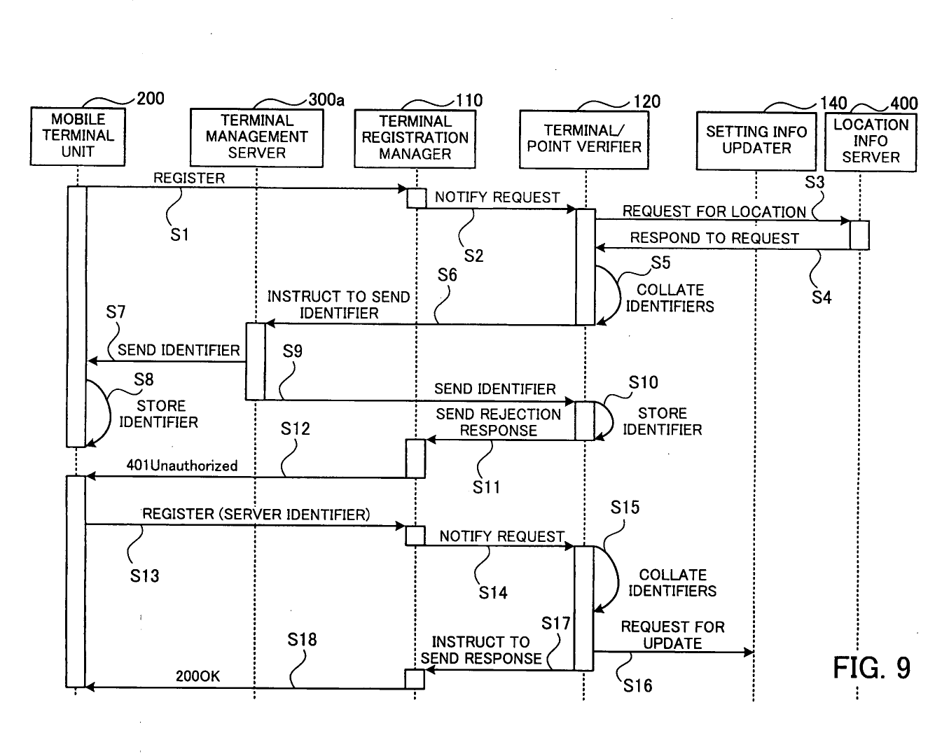

FIG. 9 is a sequence diagram illustrating the operation of the system of the first embodiment.

On arrival at the point A, the mobile terminal unit 200 transmits “REGISTER” to the PBX 100 (Step S1), in order to enable the telephone function of its own.

At this point of time, the mobile terminal unit 200 has received nothing from the terminal management server 300a. Accordingly, the terminal management server identifier storage field is empty (nothing is set), so that the terminal registration request transmitted at this time includes no terminal management server identifier therein.

The PBX 100 receives “REGISTER” from the mobile terminal unit 200, whereupon the terminal registration manager 110 sends the terminal registration request to the terminal/point verifier 120 (Step S2).

The terminal/point verifier 120 looks up the terminal management server identifier storage field in the received terminal registration request.

Also, based on the telephone number “2000” of the mobile terminal unit 200 included in the terminal registration request received in Step S2, the terminal/point verifier 120 requests the location information server 400 to notify the location of the mobile terminal unit 200 (Step S3) and then receives a response to the request (Step S4).

Subsequently, the terminal/point verifier 120 looks up the supplementary service parameter management table 131. Then, based on the telephone number “2000” included in the terminal registration request and the location “Point A” of the mobile terminal unit 200 received in Step S4, the terminal/point verifier 120 retrieves a terminal management server identifier associated with the mobile terminal unit 200, if any. At first, no such identifier is registered (nothing is set).

Then, the terminal/point verifier 120 collates the terminal management server identifier registered in the supplementary service parameter management table 131 with the terminal management server identifier included in the terminal registration request (Step S5).

Since at first no terminal management server identifier is included in the terminal registration request or registered in the terminal management server identifier field of the supplementary service parameter management table 131 as stated above, the collation results in disagreement. Accordingly, the terminal/point verifier 120 instructs the terminal management server 300a, which manages the point A where the mobile terminal unit 200 is currently located, to transmit its terminal management server identifier to the mobile terminal unit 200 (Step S6).

On receiving the instruction, the terminal management server 300a transmits the terminal management server identifier “a9ebgned” determined thereby to the mobile terminal unit 200 (Step S7).

The mobile terminal unit 200 stores the terminal management server identifier “a9ebgned”, received from the terminal management server 300a, in the identifier storage 220 (Step S8).

The terminal management server 300a also transmits the terminal management server identifier “a9ebgned” to the terminal/point verifier 120 (Step S9).

On receiving the terminal management server identifier “a9ebgned”, the terminal/point verifier 120 stores the received terminal management server identifier “a9ebgned” in the supplementary service parameter management table 131 as a terminal management server identifier associated with the mobile terminal unit 200 as well as with the current point (Step S10). At this time, if a terminal management server identifier is registered in the terminal management server identifier field of some other record associated with this mobile terminal unit, such a terminal management server identifier is deleted.

Subsequently, the terminal/point verifier 120 instructs the terminal registration manager 110 to transmit a registration rejection response (terminal registration rejection response) to the mobile terminal unit 200 (Step S11).

Accordingly, the terminal registration manager 110 transmits “401 Unauthorized” to the mobile terminal unit 200 (Step S12).

On receiving “401 Unauthorized” from the PBX 100, the mobile terminal unit 200 again transmits “REGISTER” (Step S13). At this time, the terminal management server identifier “a9ebgned” stored in the identifier storage 220 is included in the terminal management server identifier storage field.

The PBX 100 receives the terminal registration request from the mobile terminal unit 200, whereupon the terminal registration manager 110 sends the received terminal registration request to the terminal/point verifier 120 (Step S14).

The terminal/point verifier 120 looks up the supplementary service parameter management table 131 and, based on the telephone number “2000” included in the terminal registration request received in Step S13 and the location “Point A” of the mobile terminal unit received in Step S4, retrieves the terminal management server identifier “a9ebgned” associated with the mobile terminal unit 200.

Subsequently, the terminal/point verifier 120 collates the retrieved terminal management server identifier “a9ebgned” with the terminal management server identifier “a9ebgned” included in the terminal registration request (Step S15).

Since the two terminal management server identifiers, that is, “a9ebgned”, agree with each other, the terminal/point verifier 120 acquires, from the supplementary service parameter management table 131, the receiving group “A1” associated with the point A where the mobile terminal unit 200 is currently located. Then, the terminal/point verifier 120 requests the supplementary service setting information updater 140 to update (overwrite) the telephone number group associated with the acquired receiving group “A1” (Step S16). Thus, the supplementary service setting information updater 140 updates the appropriate field under the “Phone No. Group” column of the supplementary service setting information management table 151.

After the updating is completed, the terminal/point verifier 120 instructs the terminal registration manager 110 to transmit a registration completion response (terminal registration completion response) to the mobile terminal unit 200 (Step S17).

The terminal registration manager 110 checks other parameters such as information (authentication information) authenticating the mobile terminal unit 200 and, if no problem is found, transmits “200 OK” to the mobile terminal unit 200 (Step S18).

Because of the operation explained above, the mobile terminal unit 200 is allowed to use the service after it is confirmed that there is no inconsistency between the point acquired by the PBX 100 and the point where the mobile terminal unit 200 actually exists and also after the updating of the telephone number group of the receiving group associated with that point is completed. This makes it possible to provide the group call service (extension call supplementary service implemented solely in accordance with the settings of the PBX 100) appropriate to the individual points.

Operation of the terminal/point verifier 120 will be now described with reference to an exemplary case where the mobile terminal unit 200 has been moved from the point B to the point A.

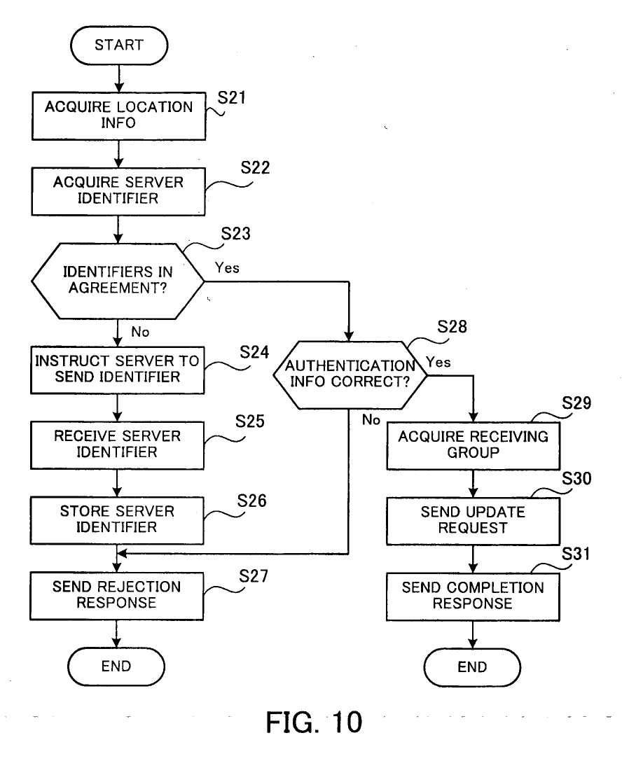

FIG. 10 is a flowchart illustrating the operation of the terminal/point verifier.

First, the terminal/point verifier 120 sends an inquiry to the location information server 400 and acquires the location “Point A” of the mobile terminal unit 200 (Step S21).

Subsequently, the terminal/point verifier 120 looks up the supplementary service parameter management table 131 and, based on the telephone number “2000” and the location “Point A”, retrieves a terminal management server identifier associated with the mobile terminal unit 200, if any (Step S22).

The terminal/point verifier 120 then determines whether or not the terminal management server identifier registered in the supplementary service parameter management table 131 agrees with the terminal management server identifier included in the terminal registration request (Step S23).

If the two terminal management server identifiers do not agree with each other (No in Step S23), the terminal/point verifier 120 instructs the terminal management server to transmit the terminal management server identifier (Step S24).

On receiving the terminal management server identifier “a9ebgned” (Step S25), the terminal/point verifier 120 stores the received terminal management server identifier “a9ebgned” in the supplementary service parameter management table 131 (Step S26).

Then, the terminal/point verifier 120 sends a terminal registration rejection response to the terminal registration manager 110 (Step S27).

If, on the other hand, the two terminal management server identifiers are found to be in agreement in Step S23 (Yes in Step S23), it is determined whether or not the aforementioned authentication information is correct (Step S28).

If the authentication information is in error (No in Step S28), the process proceeds to Step S27 where the terminal registration rejection response is sent.

On the other hand, if the authentication information is correct (Yes in Step S28), the terminal/point verifier 120 looks up the supplementary service parameter management table 131 and, based on the telephone number “2000” and the location “Point A”, acquires the receiving group “A1” (Step S29).

Subsequently, the terminal/point verifier 120 sends an update request (setting information update request) to the supplementary service setting information updater 140 so that the information associated with the acquired receiving group “A1” may be updated (Step S30).

The terminal/point verifier 120 then sends a terminal registration completion response to the terminal registration manager 110 (Step S31).

The above is the process executed by the terminal/point verifier 120.

The process of the mobile terminal unit 200 will be now described.

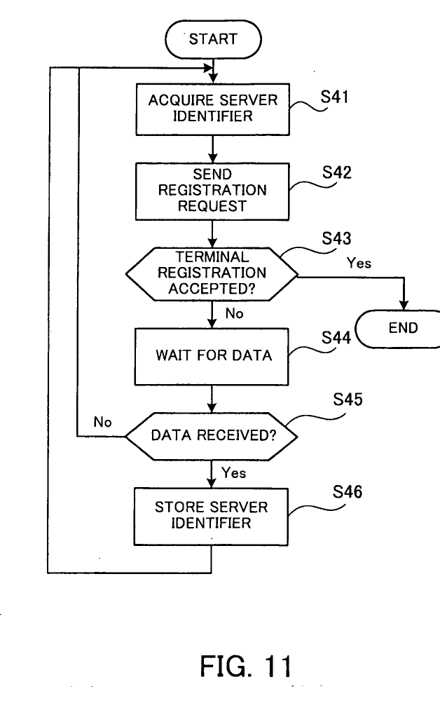

FIG. 11 is a flowchart illustrating the process executed by the mobile terminal unit.

First, if the terminal management server identifier “a9ebgned” is registered in the identifier storage 220, the terminal registration requester 210 acquires the terminal management server identifier “a9ebgned” from the identifier storage 220 (Step S41).

Subsequently, the terminal registration requester 210 transmits a terminal registration request (Step S42). If it is found in Step S41 that the terminal management server identifier “a9ebgned” is not registered in the identifier storage 220, the terminal registration request is transmitted with the terminal management server identifier storage field left empty (with nothing set) as stated above.

The terminal registration requester 210 then determines whether or not the terminal registration has been accepted (Step S43). Specifically, it is determined which of “401 Unauthorized” and “200 OK” has been received.

If it is judged that the terminal registration has been accepted, that is, if “200 OK” has been received (Yes in Step S43), the process ends.

On the other hand, if it is judged that the terminal registration has not been accepted (No in Step S43), the terminal registration requester 210 waits for data reception from the terminal management server 300a for a predetermined time (Step S44).

If data is received within the waiting time (Yes in Step S45), the terminal registration requester 210 stores the terminal management server identifier “a9ebgned” in the identifier storage 220 (Step S46). The process then proceeds to Step S41, and Step S41 and the succeeding steps are executed.

If no data is received within the waiting time (No in Step S45), the process proceeds to Step S41, and Step S41 and the following steps are executed.

The above is the process executed by the mobile terminal unit 200.

As described above, in the system of this embodiment, when a registration request is received from the mobile terminal unit 200, the terminal management server 300a (300b) transmits the terminal management server identifier “a9ebgned” to both the PBX 100 and the mobile terminal unit 200. Then, after ascertaining that the terminal management server identifier “a9ebgned” received from the mobile terminal unit 200 agrees with the terminal management server identifier “a9ebgned” acquired by the PBX 100, the PBX 100 updates the supplementary service setting information management table 151.

Since the terminal registration is not completed unless consistency is maintained between the location information (point) acquired by the PBX 100 and the actual location of the mobile terminal unit 200, it is possible to maintain the consistency between the mobile terminal unit 200 and the PBX 100 as to the settings of the group call service.

Further, the PBX 100 includes the supplementary service parameter management table 131 for storing telephone numbers, points, and receiving groups, and accordingly, the user can receive the service at the respective points without the need to make settings for each point beforehand.

Also, since the mobile terminal unit is allowed to use the same telephone number irrespective of movement from one point to another, the user is less confused when making a call.

Moreover, where the user moves from point to point taking the mobile terminal unit 200 with him/her, he/she can make use of the supplementary service without the need to pay special attention to the point where he/she is (the user's operational feeling is the same regardless of the point where he/she is).

Furthermore, as many telephone numbers as the telephone sets to be used have only to be set in the PBX 100, and therefore, compared with the case where different telephone numbers need to be set for different points, consumption of the resources can be restrained.

In this embodiment, the terminal management servers 300a and 300b generate their own terminal management server identifier. Alternatively, the terminal/point verifier 120 may be configured to generate the terminal management server identifier.

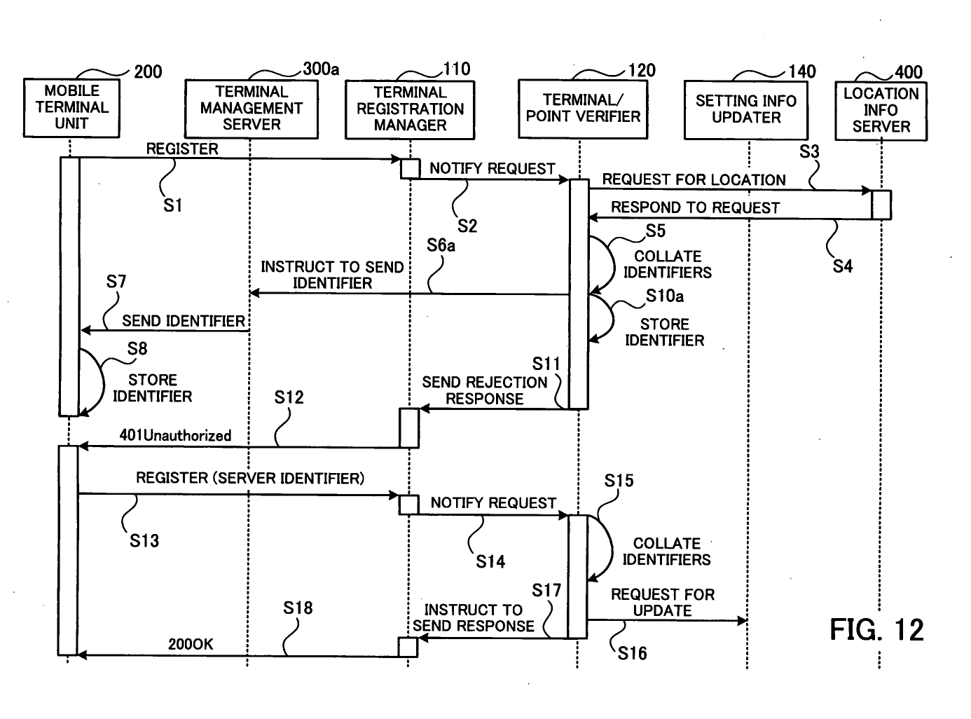

FIG. 12 is a sequence diagram illustrating a process executed in the case where the terminal management server identifier is generated by the terminal/point verifier. In FIG. 12, like reference signs are used to denote like steps already explained above with reference to FIG. 9, and description of such steps is omitted.

The terminal/point verifier 120 instructs the terminal management server 300a, which manages the point A where the mobile terminal unit 200 is currently located, to transmit the terminal management server identifier, generated by the terminal/point verifier 120, to the mobile terminal unit 200 (Step S6a).

Also, the terminal/point verifier 120 stores the terminal management server identifier generated thereby in the supplementary service parameter management table 131 as a terminal management server identifier associated with the telephone number “2000” of the mobile terminal unit 200 as well as with the point “A” (Step S10a), and then instructs the terminal registration manager 110 to transmit a registration rejection response (terminal registration rejection response) to the mobile terminal unit 200 (Step S11).

The above process also can provide the same advantageous effects as those stated above.

In the foregoing description of the embodiment, the group call service is exemplified as an extension call supplementary service which is implemented by changing the settings of the PBX 100. The service to which the embodiment is applicable is not limited to the group call service, and the embodiment can be applied to other extension call supplementary services that are implemented by changing the settings of the mobile terminal unit.

In a second embodiment described below, an extension call supplementary service implemented by changing only the settings of the mobile terminal unit will be explained taking a call parking service as an example.

Also, in a third embodiment explained below, an extension call supplementary service implemented by changing the settings of the PBX 100 as well as the settings of the mobile terminal unit will be described taking a call pickup service as an example.

### Second Embodiment

The following description of a system according to the second embodiment is focused on the differences between the first and second embodiments, and description of identical matters is omitted.

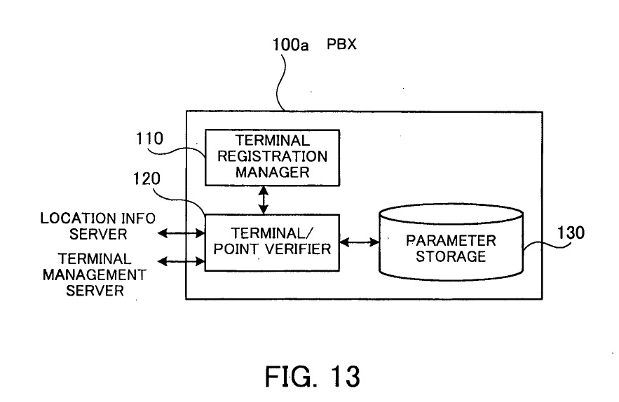

FIG. 13 is a block diagram illustrating functions of a PBX according to the second embodiment.

Compared with the PBX 100, the PBX 100a is not equipped with the functions corresponding to the supplementary service setting information updater 140 and the supplementary service setting information storage 150.

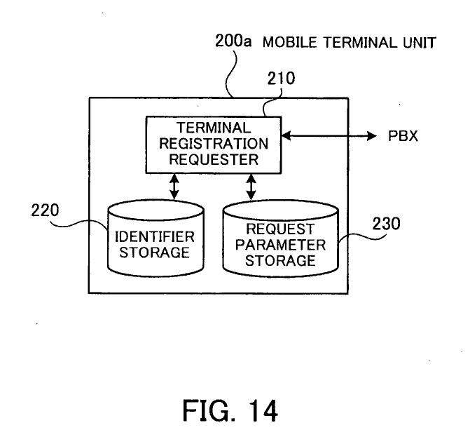

FIG. 14 is a block diagram illustrating functions of a mobile terminal unit according to the second embodiment.

The mobile terminal unit 200a of the second embodiment additionally includes a request parameter storage 230 for storing information (hereinafter referred to as “pool name”) identifying a parking location where a call is parked.

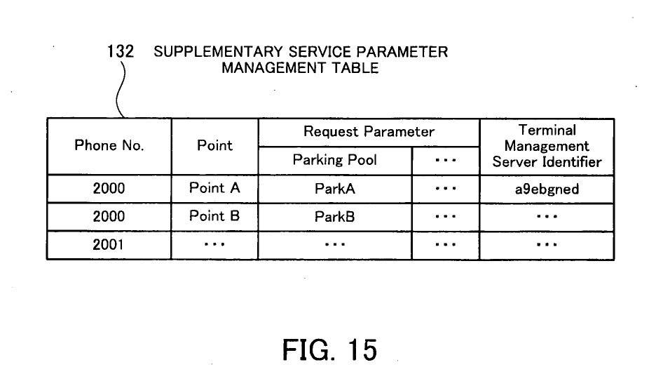

FIG. 15 illustrates a supplementary service parameter management table according to the second embodiment.

The supplementary service parameter management table 132 has a “Request Parameter” column in place of the “Set Parameter” column.

In the “Request Parameter” column, a parameter is set which is used in providing the extension call supplementary service in accordance with the settings of the mobile terminal unit 200a when the mobile terminal unit 200a is located at the point specified in the “Point” column. In FIG. 15, a call parking pool is set as a request parameter. The call parking pool represents a region where a call is parked when the call parking service is used.

In a “Parking Pool” column is set a pool name which is stored in the request parameter storage 230 when the mobile terminal unit 200a is located at the point specified in the “Point” column.

The following describes the differences between the process executed by the system of the second embodiment and that executed by the system of the first embodiment.

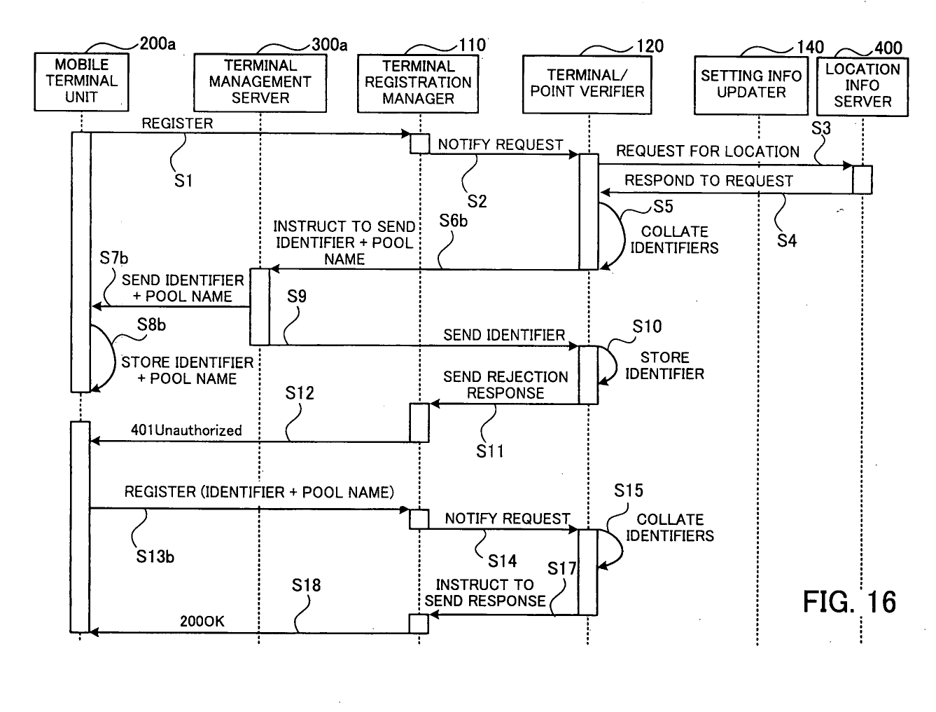

FIG. 16 is a sequence diagram illustrating operation of the system according to the second embodiment.

The terminal/point verifier 120 instructs the terminal management server 300a to transmit the pool name “Park A”, in addition to the terminal management server identifier, to the mobile terminal unit 200a from which “REGISTER” has been received (Step S6b).

On receiving the instruction, the terminal management server 300a transmits the terminal management server identifier “a9ebgned” determined thereby as well as the pool name “Park A” to the mobile terminal unit 200a (Step S7b).

The mobile terminal unit 200a stores the terminal management server identifier “a9ebgned”, received from the terminal management server 300a, in the identifier storage 220 and also stores the received pool name “Park A” in the request parameter storage 230 (Step S8b).

When “401 Unauthorized” is received from the PBX 100, the mobile terminal unit 200a again transmits “REGISTER” (Step S13b). At this time, the mobile terminal unit 200a transmits the pool name “Park A” stored in the request parameter storage 230, in addition to the terminal management server identifier “a9ebgned” stored in the identifier storage 220.

In this embodiment, Step S16 is not executed.

The following describes the difference between the process executed by the mobile terminal unit 200a of the second embodiment and that executed by the mobile terminal unit of the first embodiment.

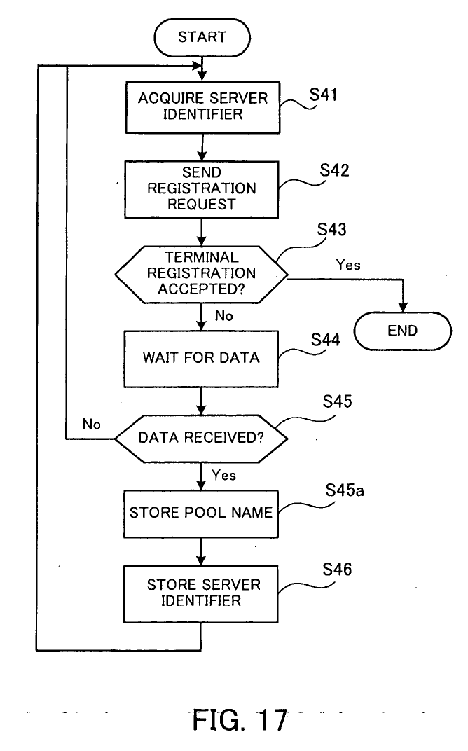

FIG. 17 is a flowchart illustrating the process executed by the mobile terminal unit of the second embodiment.

If data is received within the waiting time (Yes in Step S45), the terminal registration requester 210 stores the pool name “Park A” in the request parameter storage 230 (Step S45a).

With the system according to the second embodiment, the same advantageous effects as those of the system of the first embodiment can be achieved.

In the system of the second embodiment, the mobile terminal unit 200a is allowed to use the service after it is confirmed that there is no inconsistency between the point acquired by the PBX 100a and the point where the mobile terminal unit 200a actually exists and also after the updating of the request parameter in the mobile terminal unit 200a in accordance with the point is completed.

This makes it possible for the user to receive the extension call supplementary service implemented solely in accordance with the settings of the mobile terminal unit 200a, such as the call parking service, without the need to make settings for the individual points beforehand.

### Third Embodiment

The following description of a system according to the third embodiment is focused on the differences between the third embodiment and the foregoing first and second embodiments, and description of identical matters is omitted.

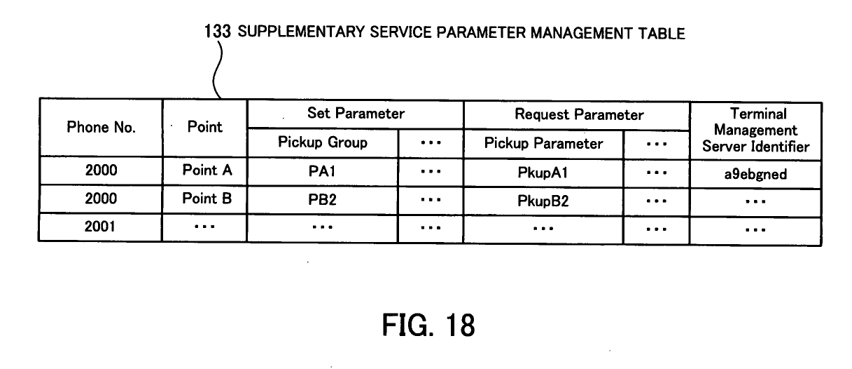

FIG. 18 illustrates a supplementary service parameter management table according to the third embodiment.

The supplementary service parameter management table 133 has a “Request Parameter” column in addition to the “Set Parameter” column.

In a “Pickup Group” column, a pickup group is set which indicates a group unit allowed to make use of the call pickup service.

In a “Pickup Parameter” column is set a pickup parameter which is stored in the request parameter storage 230 when the mobile terminal unit 200a is located at the point specified in the “Point” column.

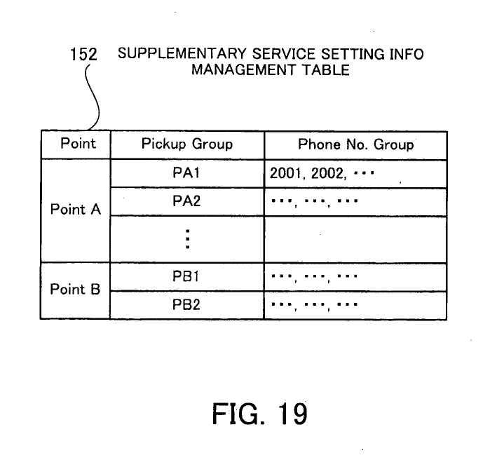

FIG. 19 illustrates a supplementary service setting information management table according to the third embodiment.

The supplementary service setting information management table 152 has columns labeled “Point”, “Pickup Group” and “Phone No. Group”. The information items in each row are associated with one another.

In the “Pickup Group” column, identification information identical in content with that explained above with reference to the supplementary service parameter management table 133 is set.

In the “Phone No. Group” column are set the telephone numbers of the mobile terminal units 200a currently belonging to the pickup group specified in the “Pickup Group” column, namely, the telephone numbers of the mobile terminal units 200a that are allowed to use the call pickup service.

The following description is focused on the differences between the process executed by the system of the third embodiment and those executed by the systems of the first and second embodiments.

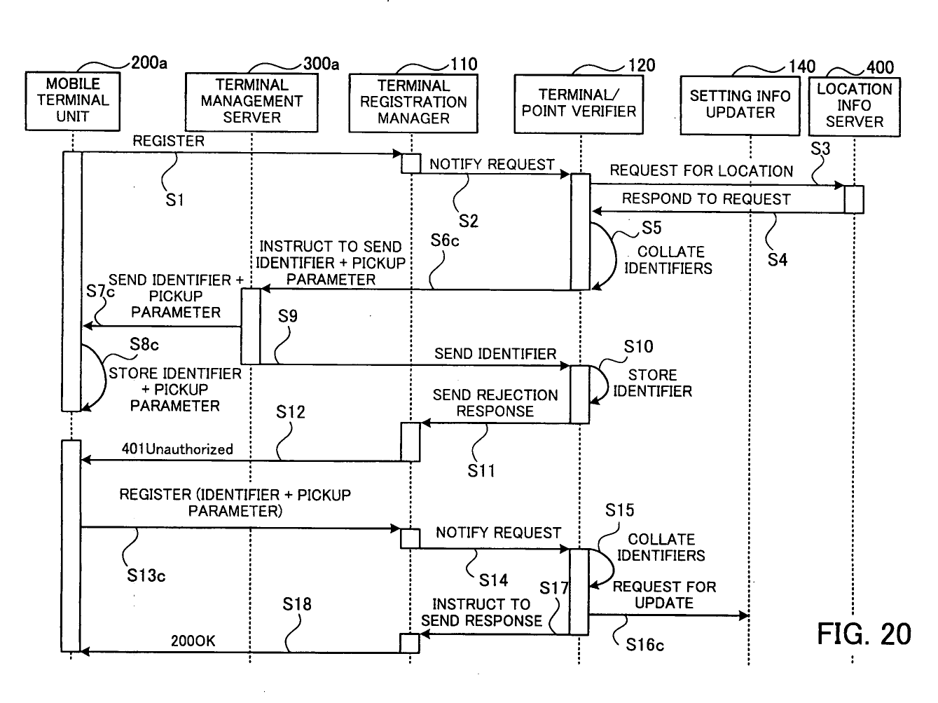

FIG. 20 is a sequence diagram illustrating operation of the system according to the third embodiment.

The terminal/point verifier 120 instructs the terminal management server 300a to transmit the pickup parameter “PkupA1”, in addition to the terminal management server identifier, to the mobile terminal unit 200a from which “REGISTER” has been received (Step S6c).

On receiving the instruction, the terminal management server 300a transmits the terminal management server identifier “a9ebgned” determined thereby as well as the pickup parameter “PkupA1” to the mobile terminal unit 200a (Step S7c).

The mobile terminal unit 200a stores the terminal management server identifier “a9ebgned”, received from the terminal management server 300a, in the identifier storage 220 and also stores the received pickup parameter “PkupA1” in the request parameter storage 230 (Step S8c).

When “401 Unauthorized” is received from the PBX 100, the mobile terminal unit 200a again transmits “REGISTER” (Step S13c). At this time, the mobile terminal unit 200a transmits the pickup parameter “PkupA1” stored in the request parameter storage 230, in addition to the terminal management server identifier “a9ebgned” stored in the identifier storage 220.

The two terminal management server identifiers, that is, “a9ebgned”, are found to agree with each other in Step S15, and accordingly, the terminal/point verifier 120 acquires, from the supplementary service parameter management table 133, the pickup group “PA1” associated with the point A where the mobile terminal unit 200a is currently located. Then, the terminal/point verifier 120 requests the supplementary service setting information updater 140 to update (overwrite) the telephone number group associated with the acquired pickup group “PA1” (Step S16c).

The following describes the differences between the operation of the terminal/point verifier 120 according to the third embodiment and that performed in the first embodiment.

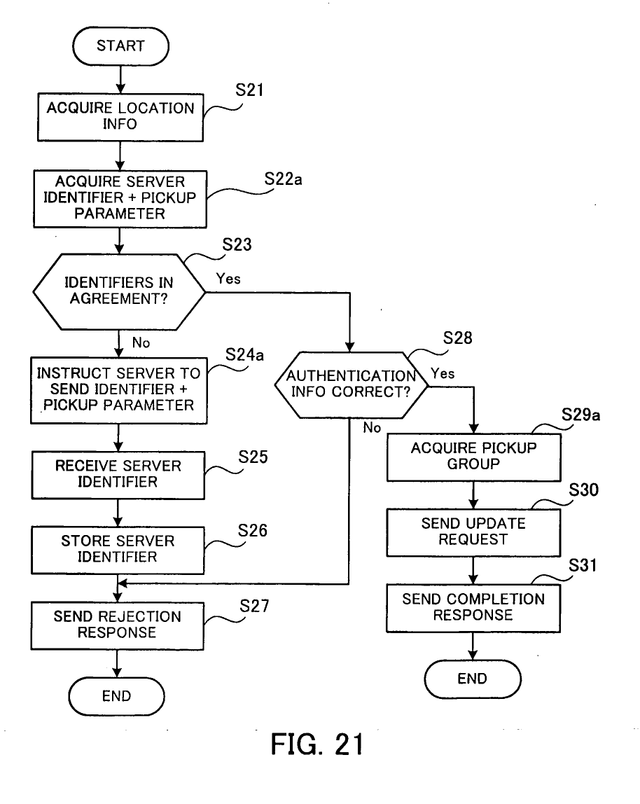

FIG. 21 is a flowchart illustrating the operation of the terminal/point verifier according to the third embodiment.

The terminal/point verifier 120 looks up the supplementary service parameter management table 133 and, based on the telephone number and the point, retrieves the pickup parameter “PkupA1” associated with the mobile terminal unit 200a, as well as a terminal management server identifier, if any (Step S22a).

Subsequently, the terminal/point verifier 120 determines whether or not the terminal management server identifier registered in the supplementary service parameter management table 133 agrees with that included in the terminal registration request (Step S23).

If the two terminal management server identifiers do not agree with each other (No in Step S23), the terminal/point verifier 120 instructs the terminal management server to transmit the terminal management server identifier and the pickup parameter “PkupA1” (Step S24a).

If the authentication information is correct (Yes in Step S28), the terminal/point verifier 120 acquires the pickup group “PA1” (Step S29a) and then sends an update request to the supplementary service setting information updater 140 so that the information associated with the acquired pickup group “PA1” may be updated.

The above is the process performed by the terminal/point verifier 120 of the third embodiment.

With the system according to the third embodiment, the same advantageous effects as those of the systems of the first and second embodiments can be achieved.

In the system of the third embodiment, the mobile terminal unit 200a is allowed to use the service after it is ascertained that there is no inconsistency between the point acquired by the PBX 100 and the point where the mobile terminal unit is actually located and also after the updating of the set parameter in the PBX 100 in accordance with the point as well as the reception of the request parameter by the mobile terminal unit 200a are completed.

This makes it possible to provide the extension call supplementary service implemented in accordance with the settings of both the PBX 100 and the mobile terminal unit 200a, such as the call pickup service, in a manner appropriate to the individual points.

The processing functions described above can be implemented by a computer. In this case, a program is prepared in which is described the process for performing the functions of the PBX 100, 100a. The program is executed by a computer, whereupon the aforementioned processing functions are accomplished by the computer. The program describing the process may be recorded on computer-readable recording media. As such computer-readable recording media, magnetic recording devices, optical discs, magneto-optical recording media, semiconductor memories, etc. may be used. Magnetic recording devices include, for example, a hard disk drive (HDD), a flexible disk (FD), a magnetic tape, etc. Optical discs include a DVD (Digital Versatile Disc), a DVD-RAM (Random Access Memory), a CD-ROM (Compact Disc Read Only Memory), a CD-R (Recordable)/RW (ReWritable), etc. Magneto-optical recording media include an MO (Magneto-Optical disk) etc.

To market the program, portable recording media, such as DVDs and CD-ROMs, on which the program is recorded may be put on sale. Alternatively, the program may be stored in the storage device of a server computer and may be transferred from the server computer to other computers via a network.

A computer which is to execute the communication service support program stores in its storage device the program read from a portable recording medium or transferred from the server computer, for example. Then, the computer loads the program from its storage device and executes the process in accordance with the program. The computer may load the program directly from the portable recording medium to perform the process in accordance with the program. Also, as the program is transferred from the server computer, the computer may sequentially execute the process in accordance with the received program.

The communication service support device disclosed herein makes it possible to maintain consistency between the communication service support device and the mobile terminal units as to the settings of the services provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions and alterations could be made hereto without departing from the spirit and scope of the invention.

What is claimed is:

1. A communication service support device for permitting a plurality of mobile terminal units to use a service, the communication service support device comprising:
a parameter storage configured to store, in a manner associated with one another, identification information identifying the respective mobile terminal units, identification information identifying a plurality of points, respectively, identification information identifying the service that the individual mobile terminal units are allowed to receive at each of the points, and identification information identifying management servers for managing the respective points;
a comparator configured to compare the identification information stored in the parameter storage and identifying the management servers with identification information transmitted from a mobile terminal unit at one of the points and identifying one of the management servers; and
a notifier configured to notify, when agreement of the identification information is found as a result of the comparison by the comparator, the mobile terminal unit from which the identification information identifying the management server has been received that the mobile terminal unit is permitted to use the service.

2. The communication service support device according to claim 1, further comprising:
a terminal information storage configured to store the identification information identifying the mobile terminal units permitted to use the service; and
a register configured to register the identification information identifying the mobile terminal unit from which the identification information has been received, in the terminal information storage when agreement of the identification information is found as a result of the comparison by the comparator.

3. The communication service support device according to claim 1, wherein, when disagreement of the identification information is found as a result of the comparison by the comparator, the identification information identifying the management server is transmitted to the mobile terminal unit.

4. The communication service support device according to claim 3, wherein the management servers each generates and transmits identification information identifying itself.

5. The communication service support device according to claim 3, wherein the notifier generates and transmits identification information identifying each of the management servers.

6. The communication service support device according to claim 3, wherein each of the mobile terminal units is configured to be able to receive the identification information identifying the management server only when the mobile terminal unit is actually located at the point managed by the management server.

7. The communication service support device according to claim 1, wherein the comparator acquires, from a location information server holding information about the points where the individual mobile terminal units are located, the point where the mobile terminal unit from which the identification information identifying the management server has been received is located.

8. A communication service support method for permitting a plurality of mobile terminal units to use a service, the communication service support method comprising:
causing a parameter storage to store, in a manner associated with one another, identification information identifying the respective mobile terminal units, identification information identifying a plurality of points, respectively, identification information identifying the service that the individual mobile terminal units are allowed to receive at each of the points, and identification information identifying management servers for managing the respective points;
causing a comparator to compare the identification information stored in the parameter storage and identifying the management servers with identification information transmitted from a mobile terminal unit at one of the points and identifying one of the management servers; and
causing a notifier to notify, when agreement of the identification information is found as a result of the comparison by the comparator, the mobile terminal unit from which the identification information identifying the management server has been received that the mobile terminal unit is permitted to use the service.

9. A computer-readable recording medium recording a communication service support program for causing a computer to perform a process of permitting a plurality of mobile terminal units to use a service,
wherein the communication service support program causes the computer to function as:
a parameter storage which stores, in a manner associated with one another, identification information identifying the respective mobile terminal units, identification information identifying a plurality of points, respectively, identification information identifying the service that the individual mobile terminal units are allowed to receive at each of the points, and identification information identifying management servers for managing the respective points;
a comparator which compares the identification information stored in the parameter storage and identifying the management servers with identification information transmitted from a mobile terminal unit at one of the points and identifying one of the management servers; and
a notifier which notifies, when agreement of the identification information is found as a result of the comparison by the comparator, the mobile terminal unit from which the identification information identifying the management server has been received that the mobile terminal unit is permitted to use the service.
